(19) United States
(12) Patent Application Publication
(10) Pub. No.: US 2005/0227682 A1
(43) Pub. Date: Oct. 13, 2005

(54) Method of supplying service configuration data to a mobile telephony device by means of a computerized terminal

(76) Inventors: Frederic Milliot, Paris (FR); Jean-Luc Ricoeur, Paris (FR)

Correspondence Address: SUGHRUE MION, PLLC, 2100 PENNSYLVANIA AVENUE, N.W., SUITE 800, WASHINGTON, DC, 20037, US

(21) Appl. No.: 10/518,403

(22) PCT Filed: Jun. 13, 2003
(86) PCT No.: PCT/FR03/01778

§ 371 Date: Dec. 17, 2004

(30) Foreign Application Priority Data
Jun. 20, 2002 (FR) 02/07629

(51) Int. Cl. H04Q 7/20

(52) U.S. Cl. 455/418; 455/435.1

(57) ABSTRACT

A method of supplying configuration data to a mobile telephony device (1) equipped with AT command management means (6) consists in, firstly, setting up a connection between said device (1) and a terminal (7) containing service configuration data and, secondly, exchanging service configuration data between the terminal (7) and the device (1) by means of selected AT commands that the AT command management means (6) of the device are able to interpret.

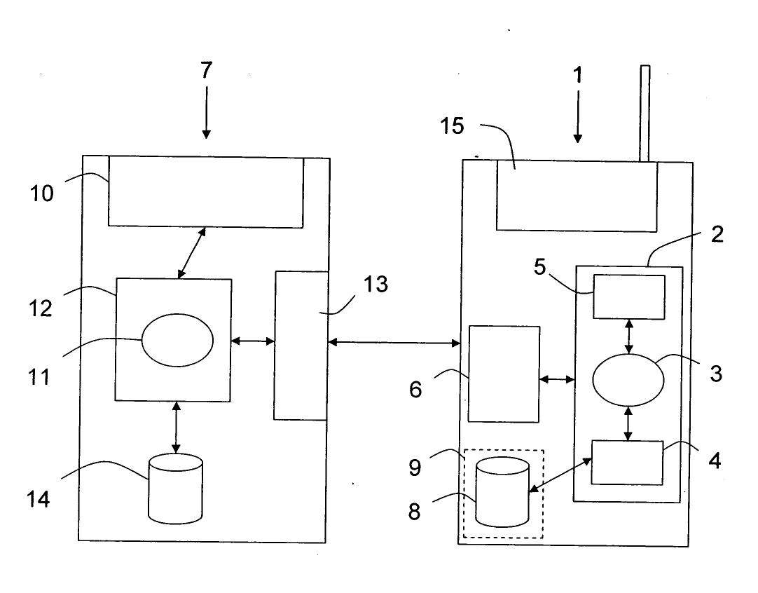

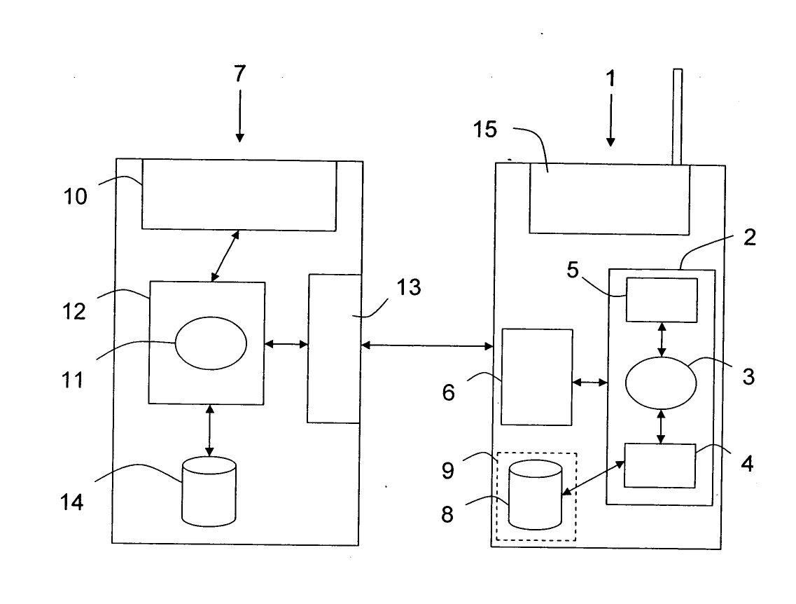

The field of the invention is that of communications in a mobile telephone network and more particularly that of supplying service configuration data to mobile telephony devices such as mobile telephones.

The person skilled in the art knows that mobile telephony devices have to be specifically configured to implement services adapted to the personal requirements of their users. This applies in particular to their browser module and on-board Java or Multi Media Messaging application modules. The configuration process uses configuration data defining profiles stored in the memory of the telephony device and to be more precise in its remanent data manager (RDM). These devices are generally sold equipped with a certain number of profiles, certain of which are used by default.

To adapt a profile to specific requirements, the user may modify or add to the configuration data that defines certain profiles using the “man-machine” interface (keypad) of the device. However, the configuration data may also be modified or added to by a remote server of the device's communication network.

In the former case the user must enter the modifications or additions using the keys of the keypad, which is particularly inconvenient and renders the device temporarily unusable, and in the latter case the user is obliged to connect to the network to download the modifications or additions, which involves a charge and monopolizes unnecessarily a connection that could be used by another user. Thus neither of those two options is satisfactory.

Consequently, an object of the invention is to propose a novel solution that is intended to remedy some or all of the above-mentioned drawbacks.

To this end it proposes a method of supplying configuration data to a mobile telephony device equipped with AT command management means, in which method a connection is first set up between said device and a data processing terminal containing service configuration data, and service configuration data is then exchanged between the terminal and the device by means of selected AT commands that the AT command management means of the device are able to interpret.

In the present context the expression “AT commands” refers to commands of the type originally developed by the American company Hayes Microcomputer Products Inc. and their standardized extensions (IS-99). Moreover, the term “terminal” refers to any type of data processing equipment provided with a user-friendly man-machine interface (keypad) and able to set up with a mobile telephony device such as a mobile telephone a “near field” cable or wireless link (for example an infrared (Irda) or Bluetooth link). Consequently, the terminal may be a fixed or portable microcomputer or a personal digital assistant (PDA).

Thus the user may prepare or load new profiles into the terminal, for example using a CD-ROM, and then transfer the new profiles into the device by setting up a simple connection between the terminal and the device. Once the connection has been set up, the user may also transfer certain profiles stored in the device into the terminal, on demand, so as to be able to modify them or add to them quickly using the user-friendly keypad of the terminal. Once the connection has been set up, the user may also send a request to delete one or more profiles from the memory of the device.

The method of the invention may have additional features, and in particular the following features, which may be used separately and/or in combination:
data representative of a provisioning (or configuration) protocol may be extracted from the device by means of selected AT commands and then sent to the terminal so that it may exchange configuration data with the device in accordance with said provisioning protocol;
the AT command management means may extract configuration data from the AT commands received from the terminal and supply it to application means requiring mobile Internet resources. In this case, the data is preferably supplied to a provisioning agent in the application means. The application means are browser means, such as a WAP browser, or onboard Java or Multi Media Messaging applications, for example.

The invention also relates to a mobile telephony device, such as a mobile telephone, comprising AT command management means adapted to set up a connection with a terminal containing service configuration data in order to exchange service configuration data with the terminal by means of selected AT commands that its AT command management means are able to interpret.

It is preferable if the device comprises application means that require mobile Internet resources and are connected to its AT command management means and adapted to receive configuration data. It is even more preferable if the application means comprise a provisioning agent capable in particular of managing configuration data coming from the AT command management means and configuration data sent to the terminal via the AT command management means.

The invention further relates to a (data processing) terminal comprising a memory for storing service configuration data and provisioning means adapted to set up a connection with a mobile telephony device of the type described above and to exchange service configuration data with the device by means of selected AT commands which the AT command management means of the device are able to interpret.

The provisioning means of the terminal are preferably adapted to send the device selected AT commands requiring it to supply data representative of its provisioning protocol, in order to be able to exchange configuration data with it in accordance with that protocol.

The provisioning means are preferably adapted to send the device selected AT commands requiring it to supply at least certain stored configuration data and, on receipt of the configuration data, to send the device AT commands adapted to modify certain of the data.

The provisioning means are preferably adapted to send the device selected AT commands requiring it to supply at least certain stored configuration data and, on receipt of the configuration data, to send the device AT commands representative of new configuration data intended to be added to other configuration data that it contains.

The provisioning means are preferably adapted to send the device selected AT commands requiring it to supply at least certain configuration data and, on receipt of the configuration data, to send the device AT commands for deleting certain of the configuration data that it contains.

The invention is particularly suitable for configuring application means operating under the HTTP, IP, GPRS or CSD protocol (and consequently the Wireless Application Protocol (WAP), since the latter may operate on top of the IP, GPRS or CSD protocol.

Other features and advantages of the invention become apparent on reading the following detailed description and examining the appended single FIGURE, which shows diagrammatically one embodiment of a device and a terminal of the invention. The drawing constitutes part of the description of the invention as well as, if necessary, contributing to the definition of the invention.

The invention relates to the supply of service configuration data to a mobile telephony device 1 using a public land mobile network (PLMN) such as a GSM, GPRS, UMTS or EDGE network.

It is considered hereinafter that the device is a mobile telephone capable of exchanging data in accordance with the Wireless Application Protocol (WAP) with other network equipment, such as servers, base transceiver stations (BTS) of a GSM (or GPRS) network, also known as Nodes B in a UMTS network, and fixed-line or mobile telephones.

The configuration data is for configuring an application module requiring mobile Internet resources. In the example shown in the single FIGURE, the application module is a WAP browser module 2 installed in the mobile telephone 1. The WAP browser module 2 includes a provisioning module 3, better known as a WAP provisioning agent, a WAP interface module 4, and a WAP management module 5.

The provisioning module 3 is connected to an AT command manager (“AT manager”) 6 providing a general interface for access to a terminal 7 by means of dedicated AT commands (see below). The provisioning module 3 is also connected to the WAP interface module 4, which enables it to access profiles stored in a memory 8 of the telephone 1. To be more precise, the (“WAP multiprofile”) interface module 4 enables the provisioning module 3 to access the memory 8 in read mode and in write mode, the memory 8 preferably being located in the remanent data manager 9 of the telephone 1.

The profiles are stored in the memory in the form of multiplets or sets of (service) configuration data. They are used, when selected by the user of the telephone 1, to configure the WAP browser module 2 via the WAP provisioning agent 3 so that it can implement services adapted to the requirements of the user. In the present context, the profile enables the WAP browser module 2 to connect to the network infrastructure. Consequently, the configuration data mainly comprises data originating from the network operator. However, it may have added to it identifiers specific to the user, for example a password and/or a user name. Some profiles are defined by default in order to propose standardized series of services.

The WAP provisioning agent 3 is also connected to the WAP management (“WAP life cycle”) module 5 and adapted to manage its activities and to report to it the “WAP state” of the browser module 2. It is preferable to operate on the profiles only when the telephone 1 is not being used for browsing.

The AT command management module 6 is conventionally adapted to receive “incoming” AT commands and convert them into (or interpret them as) procedure calls for the WAP provisioning agent 3. More generally, it manages the exchange of data between the telephone and a terminal 7.

In the present context, the term “terminal” means any type of data processing equipment that is provided with a user-friendly man-machine interface (keypad) 10, i.e. one allowing easy input of codes or instructions, and is capable of setting up a “near field” cable or radio link to the mobile telephone 1 (for example an infrared (Irda) or Bluetooth link). Hereinafter it is considered that the terminal 7 is a mobile microcomputer belonging to the user of the telephone 1 and connectable thereto by a serial link. However, it could be a fixed microcomputer or a personal digital assistant (PDA).

As shown in the single FIGURE, the terminal 7 is equipped with a WAP provisioning client module 11 adapted to send the telephone 1 dedicated AT commands for reading, modifying, deleting, adding and adding to the profiles stored in its memory 8. This module 11 also enables the user to assign a profile the default profile status and to access certain parameters, such as the identifier of a default profile or the maximum number of profiles managed by the telephone 1.

The WAP provisioning client module 11 is preferably located in the management module 12 of the terminal 7, which is connected to a connection interface 13 for setting up the connection with the telephone 1 in particular. Moreover, the terminal 7 preferably comprises a memory 14 adapted to receive configuration data defining new profiles for the telephone 1 or updating-profiles already used by said telephone 1. Such profiles or profile updates may be downloaded previously by the user via the terminal 7 or obtained from a CD-ROM supplied by the operator of the mobile telephone network used by the user's telephone 1, for example.

As indicated above, for it to be possible to exchange configuration data between the terminal 7 and the telephone 1, it is essential that a connection be set up first, or in other words that a WAP provisioning client module 11 of the terminal 7 be connected to the AT command management module 6 of the telephone 1.

Once this connection has been set up, the configuration data provisioning (“AT provisioning”) procedure may begin. It consists in reading configuration data in the telephone 1 at the request of the terminal 7 and writing configuration data in the telephone 1 to modify the content of its memory 8, also at the request of the terminal 7.

In the present context the expression “read operation” refers to all transfers of data from the telephone 1 to the terminal 7, which are generally intended to transfer into the terminal 7 a particular profile or the stored list of profiles, and whose implementation depends on the availability of the requested data. The expression “write operation” refers to all transfers of data from the terminal 7 to the telephone 1. Only certain profiles may be modified (or updated), deleted or added. For example, if a profile is locked, it may not be modified or deleted. The same applies to the list of profiles. A profile is preferably written (added or modified) using a single data sequence, and only the WAP provisioning agent 3 is able to do this, via the interface module 4.

These read and write operations are preferably preceded by an operation to determine the provisioning protocol version used by the telephone 1, because each telephone may have a specific provisioning protocol version, which defines the format of sequences of configuration data units, the order of the configuration data units, and the structure used by the telephone 1 to store profiles in its memory 8.

The structure for storing a profile consists of a set of parameters that may be divided into six categories of parameters or variables, for example:
“Default Profile”: this a Boolean variable indicating whether a profile is the default profile or not;
“Using Flag”: this a Boolean variable indicating if a profile is used (“TRUE”) or not (“FALSE”); if the user wishes to add a new profile to the list of profiles stored in the memory 8, then Using Flag is set to TRUE;
“Provisioning Version”: this is a parameter designating the version of the provisioning protocol used by the telephone 1;
“Profile Information”: this groups parameters such as “Profile Name”, “Profile modification Flag”, etc.;
“Bearer Parameter”: this groups parameters such as “Bearer Type”, “Profile specific Parameter”, etc.;
“WAP Gateway Parameter”: this groups parameters such as “IP Address”, “Port Number”, “Home URL”, etc.

The structure of a list of profiles comprises two sections:
general information on the profile, such as, for example: “ProfileListLock”, which specifies a condition for adding, modifying or deleting a profile, “DefaultProfileID”, which is the identifier designating the default profile in the list of profiles, “MaxNumberProfiles”, which specifies the maximum number of profiles managed by the telephone 1 (and not the number of profiles used by the browser module 2), “NumberProfilesUsed”, which specifies the number of profiles used by the browser module 2 at the time of the request, and “Provisioning Version”, which is the identifier designating the version of the provisioning protocol used by the telephone 1; and
information concerning all the standard profiles used by the telephone 1, such as, for example: “ProfileID”, “ProfileName” and “ProfileLock”.

A data unit is defined by two fields, a length field and a value field. For preference no separator is used between two successive data units, which may have varying lengths. Each length field preferably comprises a byte that specifies the number of bytes in the value field. Consequently, if the value of the byte defining the length field is equal to 0 (zero), then the length field is not followed by a value field.

The information on the data units is taken directly from the structure fields of the telephone 1. Moreover, each unit has a data unit sequence identifier to allow identification of the various data units within a sequence. Also, if a multibyte representation is used, it is preferable to use the “Little Indian” (LSB) convention. Furthermore, each sequence preferably terminates with a specific character.

As indicated hereinabove, a sequence is defined by an ordered series of data units, and each unit has a series identifier. The series identifier is preferably not transmitted during a data transfer, but the telephone 1 and the terminal 7 must conform to it when they compose their sequences.

Three types of sequence are preferably defined, one for sending the complete list of profiles, one for sending a profile, and one for the provisioning protocol version.

The sequence used to send the provisioning protocol version to the terminal 7 preferably comprises only one data unit.

The sequence used to transmit the list of stored profiles to the terminal 7 preferably comprises a first part of fixed length and a second part of variable length.

To be more precise, the first part advantageously comprises 10 bytes for defining general information regarding the list, for example. For instance, five pairs of bytes respectively define the provisioning protocol version, the maximum number of profiles managed by the telephone 1, the number of profiles used by the telephone 1, the identifier of the default profile, and a lock for the list of profiles (“list lock”), such as a Boolean variable specifying whether it is possible to add a profile to a list or delete a profile from a list, for example.

The second part advantageously comprises 38 bytes for defining each profile used in the telephone 1, for example, comprising three bytes for the length field and 35 bytes for the value field. The bytes for each profile define its name, its identifier, and its profile lock, for example.

The sequence used to send a particular stored profile to the terminal 7 preferably comprises a maximum of 442 bytes, for example, consisting of 25 bytes for the length field and 417 bytes for the value field. By way of illustrative and non-limiting example, a profile sequence may comprise:
1 byte for the “Provisioning Version” field defining the provisioning protocol version and 1 byte for its length field;
1 byte for the “Boolean Default Profile” field and 1 byte for its length field;
1 byte for the length field and 33 bytes for the “Profile Name” field and 1 byte for its length field;
1 byte for the “Profile Lock” field and 1 byte for its length field;
4 bytes for the “Gateway IP Address” field and 1 byte for its length field;
2 bytes for the “Gateway Port” field and 1 byte for its length field;
100 bytes for the “Home Page URL” field and 1 byte for its length field;
4 bytes for the “Bearer Used” field and 1 byte for its length field;
1 byte for the “Presence Bearer CSD” field and 1 byte for its length field;
1 byte for the “CSD User Name Length” field and 1 byte for its length field;
32 bytes for the “CSD User Name” field and 1 byte for its length field;
1 byte for the “CSD Password Length” field and 1 byte for its length field;
32 bytes for the “CSD Password” field and 1 byte for its length field;
4 bytes for the “CSD Access Type” field and 1 byte for its length field;
22 bytes for the “CSD Phone Number” field and 1 byte for its length field;
1 byte for the “CSD Connection Speed” field and 1 byte for its length field;
1 byte for the “Presence Bearer GPRS” field and 1 byte for its length field;
1 byte for the “GPRS User Name Length” field and 1 byte for its length field;
32 bytes for the “GPRS User Name” field and 1 byte for its length field;
1 byte for the “GPRS Password Length” field and 1 byte for its length field;
32 bytes for the “GPRS Password” field and 1 byte for its length field;
4 bytes for the “GPRS Authentication Indicator” field and 1 byte for its length field;
101 bytes for the “GPRS APN” field and 1 byte for its length field;
4 bytes for the “GPRS IP Address” field and 1 byte for its length field;
1 byte for the “Using Flag” field and 1 byte for its length field.

The parameters and variables defined above constitute configuration data. As indicated above, configuration data is exchanged by means of standard AT commands. In the present context, the expression “AT commands” refers to the commands initially developed by the American company Hayes Microcomputer Products Inc. together with all extensions thereof designated by the IS-99 standard.

To implement the invention, and in particular to enable a connection to be set up between the WAP provisioning client module 11 of the terminal 7 and the AT command management module 6 of the telephone 1, other AT commands are provided for reading, writing (modifying or adding), and deleting profiles.

These additional AT commands preferably have the following general definition and the following general syntax: AT PROV_WAP=PROVCOMMAND [PROFILEID]. This type of AT command is preferably associated with a time-out enabling the terminal 7 to detect a problem in the telephone 1. This time-out is equal to approximately one minute, for example.

By way of illustrative example, the additional AT commands may comprise:
A command for obtaining the version of the provisioning protocol of the telephone 1: AT PROV_WAP=V? This command has no parameters. The response to this command (request) is “Provisioning Version” if the version is known or PROV NOK if the version is unavailable, for example.
A command for obtaining (reading) data: AT PROV_WAP=R [PROFILEID]. The purpose of this command is to request WAP information from the telephone 1. If no parameters have been set, this command requests the list of stored profiles. The list is preferably updated by the browser module 2 before it is transferred. The optional parameter [PROFILEID] tells the telephone 1 that the terminal 7 requires particular data concerning a profile. It designates a profile identifier (number). Consequently, its value is less than the maximum number of profiles managed by the telephone 1. The response to this command (request) is PROV OK if the processing is executed correctly or PROV NOK if the data is unavailable, for example;
A command for writing data: AT PROV_WAP=W, PROFILEID. This command tells the telephone 1 that the terminal 7 wishes to update the data of a particular profile. The purpose of the parameter [PROFILEID] is to give the telephone 1 the identifier of the profile that it is required to update. Consequently, its value is less than the maximum number of profiles managed by the telephone 1. The response to this command (request) is PROV OK if the processing is executed correctly or PROV NOK if the write operation is impossible, for example.
A command for deleting data: AT PROV_WAP=D , PROFILEID. This command tells the telephone 1 that the terminal 7 wishes to delete certain data of a particular profile. The purpose of the parameter [PROFILEID] is to give the telephone 1 the identifier of the profile that it is required to modify or delete. Consequently, its value is less than the maximum number of profiles managed by the telephone 1. The response to this command (request) is PROV OK if the processing is executed correctly or PROV NOK if the delete operation is impossible, for example.
A command for creating a new profile: AT PROV_WAP=C. This command tells the telephone 1 that the terminal 7 wishes to add a new profile to the list stored in its memory 8. The parameter [PROFILEID] does not accompany this command since it is not the terminal 7 that manages the assignment of profile parameters. The response to this command (request) is PROV OK , PROFILEID if the processing is executed correctly or PROV NOK if the create operation is impossible, for example.

All these AT commands are present in the WAP provisioning client module 11 of the terminal 7 and the AT command managing module of the telephone 1 is able to interpret them once it has been adapted accordingly. Consequently, a user of a telephone 1 who wishes to read or to modify the WAP profile stored in the memory 8 of said telephone, sets up a connection between the terminal 7 and the telephone 1 on loading the application associated with the WAP provisioning client module 11, for example a serial, infrared or Bluetooth connection, and then uses the keypad 10 to select a new profile to be transferred or a profile update stored in the memory 14 or on a CD-ROM, and, where necessary, after adapting the new profile or profile update to the user's own requirements, instructs the WAP provisioning client module 11 to send the AT command management module 6 of the telephone 1, via the module 11 and the connection interface 13, requests corresponding to the selected process (in this instance this is a write operation), in the form of AT commands of the type described above. These AT commands, and any configuration data that they contain, are then interpreted by the AT command management module 6 as WAP format procedure calls and transmitted to the WAP provisioning agent 3, which then sends the WAP management module 5 messages to tell it the processing that the AT command management module 6 requires, in order for it to be released quickly.

Provided that the WAP management module 5 authorizes it, the WAP provisioning agent 3 then executes a standard WAP process corresponding to the processing that the AT command management module 6 requires. WAP processes being well-known to the person skilled in the art, and properly speaking forming no part of the invention, they are not described here. They are described on the World Wide Web site www.wapforum.org in particular.

The result of the WAP processing is transmitted to the AT command management module 6, which converts it to AT commands that it then sends to the WAP provisioning client module 11. In other words, the AT command management module 6 transfers the data over the line in “data” mode and then switches to an interpretation mode.

By means of the invention, the user no longer has to use the keypad 15 of the mobile telephone 1 and/or to connect to the network, and bear the associated costs, in order to modify, add, or delete a service configuration profile.

The WAP browser module 2, the provisioning (“WAP provisioning agent”) module 3, the WAP (“WAP multiprofile”) interface module 4, the WAP management (“WAP life cycle”) module 5, the provisioning (“AT manager”) module (agent) 6, the remanent data manager module 9 and the WAP provisioning client module 11 may be implemented in the form of electronic circuits, software (or data processing) modules, or a combination of circuits and software.

The invention also proposes a method of supplying configuration data to a mobile telephony device 1 equipped with AT command management means.

The method may be implemented using the device 1 and the terminal 7 described above. The main and optional functions and subfunctions of the steps of the method being substantially identical to the main and optional functions and subfunctions of the means constituting the device 1 and the terminal 7, only the steps implementing the main functions of the method of the invention are summarized hereinafter.

The method of the invention consists in setting up a connection between a device 1 and a data processing terminal 7 holding service configuration data and then exchanging service configuration data between the terminal and the device using selected AT commands that the AT command management means of the device are able to interpret.

Data representative of the provisioning protocol version that it uses is preferably extracted from the memory 8 of the device 1 by means of selected AT commands, after which the extracted data is sent to the terminal 7 so that it may exchange configuration data with the device 1 in accordance with this provisioning protocol version.

Configuration data contained in AT commands from the terminal 7 may also be extracted by the AT command management means 6 of the device 1 in order to supply its browser means 2 and preferably the provisioning agent 3 implemented in the browser means 2.

The invention is not limited to the embodiments of a method, device and terminal described above by way of example only, and encompasses all variants that the person skilled in the art might envisage that fall within the scope of the following claims.

Thus there is described above one example of application of the invention to the exchange of WAP browser module configuration data. However, the invention applies generally to configuring all applications that require mobile Internet resources, and in particular onboard Java or Multi Media Messaging applications. Furthermore, the invention is not limited to the WAP exchange protocol. It relates also to the HTTP, IP, GPRS or CSD protocol.

1. A method of supplying configuration data to a mobile telephony device (1) equipped with AT command management means (6), characterized in that it comprises the steps of: i) setting up a connection between said device (1) and a terminal (7) containing service configuration data and ii) exchanging service configuration data between the terminal (7) and the device (1) by means of selected AT commands that the AT command management means (6) of said device are able to interpret.

2. A method according to claim 1, characterized in that data representative of a provisioning protocol is extracted from the device by means of selected AT commands and then sent to the terminal (7) so that said terminal may exchange said configuration data with said device in accordance with said provisioning protocol.

3. A method according to claim 1, characterized in that said AT command management means (6) extract said configuration data from the AT commands received from the terminal (7) in order to supply it to application means (2) requiring mobile Internet resources (2).

4. A method according to claim 3, characterized in that said application means (2) are selected from the group comprising browser means (2), onboard Java application means, and onboard Multi Media Messaging application means.

5. A method according to claim 3, characterized in that said configuration data is supplied to a provisioning agent (3) in said application means (2).

6. A method according to claim 1, characterized in that at least certain of the configuration data stored in a memory (8) of the device (1) is extracted in order to send it to said terminal (7) and in that, on receipt of said data, the device (1) is sent AT commands for modifying certain data, after which the modified data is stored in said memory (8).

7. A method according to claim 6, characterized in that at least certain of the configuration data stored in the memory (8) is extracted in order to send it to said terminal (7) and in that, on receipt of said data, the device (1) is sent AT commands representative of new configuration data, after which the new data is stored in said memory (8).

8. A method according to claim 6, characterized in that at least certain of the configuration data stored in the memory (8) is extracted in order to send it to said terminal (7) and in that, on receipt of said data, the device (1) is sent AT commands for deleting certain data from said memory (8).

9. A mobile telephony device comprising AT command management means (6), characterized in that said AT command management means (6) are adapted to set up a connection with a terminal (7) containing service configuration data in order to exchange service configuration data with said terminal by means of selected AT commands that its AT command management means (6) are able to interpret.

10. A device according to claim 9, characterized in that it comprises application means requiring mobile Internet resources (2) connected to said AT command management means (6) and adapted to receive said configuration data.

11. A device according to claim 10, characterized in that said application means (2) are selected from the group comprising browser means, on-board Java application means, and on-board Multi Media Messaging application means.

12. A device according to claim 10, characterized in that said application means (2) comprise a provisioning agent (3) adapted to manage the received configuration data and the configuration data to be sent to said terminal (7).

13. A device according to claim 9, characterized in that it comprises a memory (8) adapted to store said received data.

14. A data processing terminal comprising a memory for storing service configuration data, characterized in that it comprises provisioning means (11) adapted to set up a connection with a mobile telephony device (1) according to claim 9 and to exchange service configuration data with said device (1) by means of selected AT commands which the AT command management means (6) of said device are able to interpret.

15. A terminal according to claim 14, characterized in that said provisioning means (11) are adapted to send said device (1) selected AT commands requiring the supply of data representative of a provisioning protocol in order to exchange said configuration data with said device (1) in accordance with said protocol.

16. A terminal according to claim 15, characterized in that said provisioning means (11) are adapted to send said device (1) selected AT commands requiring the supply of at least certain of its configuration data and, on receipt of said configuration data, to send said device (1) AT commands for modifying certain data.

17. A terminal according to either claim 15, characterized in that said provisioning means (11) are adapted to send said device (1) selected AT commands requiring the supply of at least certain of its configuration data and, on receipt of said configuration data, to send said device (1) AT commands representative of new configuration data to be added to the other configuration data that it contains.

18. A terminal according to claim 15, characterized in that said provisioning means (11) are adapted to send said device (1) selected AT commands requiring the supply of at least certain of its configuration data and, on receipt of said configuration data, to send said device (1) AT commands for deleting certain of the configuration data that it contains.

19. The method according to claim 1 wherein said connection is selected from the group consisting of a cable connection and a radio connection.

20. A method according to claim 19, characterized in that said radio connection is selected from the group consisting of an infrared connection and a “Bluetooth” connection.

21. The use of a method, device and terminal according to claim 1 to configure application means (2) operating in accordance with a protocol selected from the WAP, HTTP, IP, GPRS, and CSD protocols.
